(19) United States
(12) Patent Application Publication
(10) Pub. No.: US 2009/0260735 A1
(43) Pub. Date: Oct. 22, 2009

(54) BEAD CORD AND VEHICLE TIRE

(75) Inventors: Hiroshi Sasabe, Utsunomiya-shi (JP); Hitoshi Wakahara, Utsunomiya-shi (JP); Yuichi Sano, Utsunomiya-shi (JP); Kenichi Okamoto, Itami-shi (JP)

Correspondence Address: OSHA LIANG L.L.P., TWO HOUSTON CENTER, 909 FANNIN, SUITE 3500, HOUSTON, TX, 77010, US

(73) Assignees: SUMITOMO (SEI) STEEL WIRE CORP., Itami-shi, Hyogo (JP); SUMITOMO ELECTRIC TOCHIGI CO., LTD., Utsunomiya-shi, Tochigi (JP)

(21) Appl. No.: 12/064,325

(22) PCT Filed: Apr. 2, 2007
(86) PCT No.: PCT/JP2007/057402

§ 371 Date: Feb. 20, 2008

(30) Foreign Application Priority Data
Apr. 5, 2006 (JP) 2006-104549
Mar. 15, 2007 (JP) 2007-067087

(51) Int. Cl. B60C 15/04

(52) U.S. Cl. 152/540

(57) ABSTRACT

A bead cord is described including an annular core and a side wire. The side wire is helically wound around the annular core. Further, the annular core is made of a strand wire. The strand wire includes a plurality of twisted core wires. The plurality of core wires may have substantially the same diameter.

### TECHNICAL FIELD

The present invention relates to a bead cord used as, for example, a reinforcement for bead portions of vehicle tires, and a vehicle tire.

### BACKGROUND ART

Bead cords disclosed in, for example, Patent Documents 1 and 2 are known as bead cords used as reinforcements for bead portions of vehicle tires. The bead cord disclosed in Patent Document 1 includes a core wire and a plurality of side wires arranged and twisted around the core wire. The bead cord disclosed in Patent Document 2 includes a steel filament which is annularly wound and twisted in a plurality of turns without a core filament being interposed.

Patent Document 1: Japanese Unexamined Patent Application Publication No. 5-163686

Patent Document 2: Japanese Unexamined Patent Application Publication No. 9-273088

### DISCLOSURE OF INVENTION

### Problem to be Solved by the Invention

However, the above-mentioned conventional techniques have the following problems: In Patent Document 1, the core wire and the side wires are composed of the same material with the same diameter, and thus the core wire is lack of rigidity for tension in winding the side wires and is thus deformed. Also, since the core wire is a single wire while the side wires are twisted together, elongations of the core wire and the side wires at an external load are different so that the core wire is less elongated than the side wires. Therefore, for example, after a vehicle tire is molded, it becomes difficult to incorporate a bead cord into the periphery of a rim. In addition, the core wire is easily broken or fatigued in an early stage, thereby decreasing the life of the core wire.

In Patent Document 2, since there is no base material for winding the filament, it is difficult to satisfactorily wind the filament. Also, the structure of the bead cord becomes unstable as the number of turns of the filament increases, and thus the length per turn of the filament easily varies due to dropping of the filament in the spaces between the adjacent turns of the filament. Therefore, the elongation per turn of the filament at an external load varies, thereby causing the same problem as in Patent Document 1 that it becomes difficult to incorporate a bead cord into the periphery of a rim of a vehicle tire.

The present invention provides a bead cord capable of making uniform elongations of an annular core and a side wire at an external load and a vehicle tire.

### Means for Solving the Problem

A bead cord of the present invention includes an annular core and a side wire helically wound around the annular core, wherein the annular core is composed of a strand wire including a plurality of twisted core wires.

In the present invention, the strand wire including a plurality of twisted core wires is formed in an annular shape to form the annular core, and thus the annular core is easily elongated as compared with a single-wire structure annular core. In this case, the elongation of the annular core can be appropriately controlled by changing the twisting pitch of each core wire. Therefore, when an external load is applied to the bead cord, the elongation of the annular core becomes close to that of the side wire, thereby increasing unity between the annular core and the side wire and improving the overall elongation of the bead cord.

It is preferred to satisfy the following equation:

$${\sum }_{i = 1}^{n} {d}_{ci}^{4} \geq {d}_{o}^{4} \qquad [ Equation 1 ]$$

wherein n is the number of the core wires, d_{ci} is the diameter of the core wires, and dₒ is the diameter of the side wire.

Since the side wire is wound around the annular core, the annular core is required to have some degree of rigidity. Therefore, the inventors repeatedly investigated the flexural rigidity of the annular core and the side wire and the windability of the side wire by trial and error. As a result, the above-described equation was derived. Namely, if the core wires of the annular core and the side wire are composed of the same material main component, the flexural rigidity of both wires is proportional to bending moment and is proportional to the fourth power of the wire diameter. The flexural rigidity of the annular core is also proportional to the number of the core wires. Therefore, in order to secure the windability of the side wire, the flexural rigidity of the annular core is preferably at least equivalent to the flexural rigidity of the side wire.

Further, a plurality of core wires preferably has substantially the same wire diameter. The strand wire including a plurality of twisted core wires is formed by an exclusive stranding machine. In this case, when the core wires have substantially the same wire diameter, a change with time of residual torsion inherent in each core wire can be suppressed, thereby decreasing the residual stress of the annular core and stabilizing the shape of the annular core when the annular core is formed. Therefore, in a subsequent step of helically winding the side wire around the annular core to form the bead cord, winding of the side wire is not adversely affected, resulting in stabilization of the shape of the bead cord. The expression, “substantially the same wire diameter”, is an idea including a case in which the wire diameters of both wires are completely the same as well as a case in which the diameters of both wires are slightly different (for example, 8% or less).

It is also preferred that the winding direction of the side wire on the annular core is opposite to the twisting direction of the plurality of core wires. In this case, when the side wire is helically wound around the annular core to form the bead cord, the side wire less drops into the ply (space between the core wires) of the annular core. Consequently, the windability of the side wire can be maintained.

Further, it is preferred that the end surfaces of each of the core wires which form the annular core are welded together. In this case, the annular core which is not easily broken can be easily obtained without increasing the diameter of the joints of the core wires. Therefore, an increased-diameter portion is not formed in the annular core, and thus the windability of the side wire around the annular core can be improved.

The twist angle of each core wire is preferably 5.0 to 18.5°. When the twist angle of each core wire is 5.0° or more, parting between the ends of the core wires can be suppressed when the end surfaces of the core wires are welded, thereby improving the workability of welding of the core wires. When the twist angle of each core wire is 18.5° or less, an excessive elongation of the annular core can be prevented. Therefore, even if an external load is applied to the bead cord, the unity between the annular core and the side wire is maintained.

The material of the core wires is preferably alloy steel containing 0.08 to 0.27% by mass of C, 0.30 to 2.00% by mass of Si, 0.50 to 2.00% by mass of Mn, and 0.20 to 2.00% by mass of Cr, and further containing at least one of Al, Nb, Ti, and V in a range of 0.001 to 0.100% by mass, the balance being composed of Fe and inevitable impurities. In this case, the weldability between the end surfaces of the each core wire can be increased, suppressing a decrease in breaking strength of the annular core.

The material of the core wires may be carbon steel containing 0.28 to 0.56% by mass of C. In this case, it is possible to sufficiently secure the strength required for the core wires and ductility of the core wires after the end surfaces of each core wire are welded together.

A vehicle tire of the present invention includes the above-described bead cord embedded in a bead portion.

As described above, by using the above-described bead cord, the elongation of the annular core is brought close to the elongation of the side wire when en external load is applied to the bead cord, and thus the unity between the annular core and the side wire is increased to improve the overall elongation characteristics of the bead cord. Therefore, the bead cord can be easily embedded in the bead portion.

### ADVANTAGE OF THE INVENTION

According to the present invention, the elongations of the annular core and the side wire can be made uniform at an external load. As a result, the bead cord can be easily extended outward in the radial direction, and thus the bead cord can be easily incorporated into the periphery of a rim after a vehicle tire is molded. Also, early breaking of the annular core can be prevented, thereby permitting an attempt to increase in life of the annular core.

### BRIEF DESCRIPTION OF THE DRAWINGS

FIG. 1 is a sectional view showing a vehicle tire including a bead cord according to an embodiment of the present invention.

FIG. 2 is a perspective view of the bead cord shown in FIG. 1.

FIG. 3 is an enlarged partial perspective view of the bead cord shown in FIG. 2.

FIG. 4 is a sectional view of the bead cord shown in FIG. 2.

FIG. 5 is an enlarged partial perspective view of the strand wire shown in FIG. 3.

FIG. 6 is a front sectional view of the connecting member shown in FIG. 3.

FIG. 7 is a schematic view of the constitution of a stranding machine for forming the strand wire shown in FIG. 3.

FIG. 8 is a schematic view showing a state in which a side wire is helically wound around an annular core shown in FIG. 3.

FIG. 9 is a schematic view of the constitution of a wire winding machine for helically winding a side wire around an annular core shown in FIG. 3.

FIG. 10 is a schematic view showing the procedures for winding a side wire around an annular core using the wire winding machine shown in FIG. 9.

FIG. 11 is an enlarged partial perspective view showing a modified example of the bead cord shown in FIG. 3.

FIG. 12 is an enlarged partial perspective view showing another modified example of the bead cord shown in FIG. 3.

### REFERENCE NUMERALS

1 . . . vehicle tire, 6 . . . bead portion, 9 . . . bead cord, 10 . . . annular core, 11 . . . side wire, 12 . . . core wire, 13 . . . strand wire.

### BEST MODE FOR CARRYING OUT THE INVENTION

A bead cord and a vehicle tire according to preferred embodiments of the present invention will be described in detail below with reference to the drawings. In the drawings, the same or equivalent components are denoted by the same reference numeral, and duplicated description is omitted.

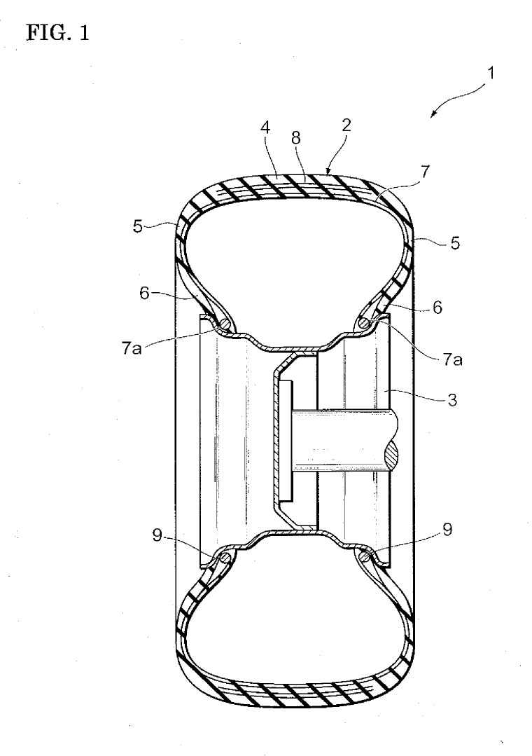

FIG. 1 is a sectional view showing a vehicle tire including a bead cord according to an embodiment of the present invention. In FIG. 1, a vehicle tire 1 includes a tire body 2 to which a rim 3 is mounted. The tire body 2 has a tread portion 4, a pair of sidewalls 5 extending inward from the both ends of tread portion 4 in the radial direction of the tire, and a pair of bead portions 6 to be engaged into the rim 3.

Also, a carcass 7 and a multilayer belt 8 are buried in the inside of the tire body 2. The carcass 7 is provided to extend from the tread portion 4 to each of the bead portions 6 through each sidewall 5. The both ends of the carcass 7 are bent at each of the bead portions 6. The belt 8 is provided in the tread portion 4 outward of the carcass 7 in the radial direction of the tire.

In each of the bead portions 6, an annular bead cord 9 is buried to extend in the circumferential direction of the tire. The bead cord 9 is a reinforcing material for reinforcing the bead portions 6 and is disposed to engage with the folded portions 7a of the carcass 7.

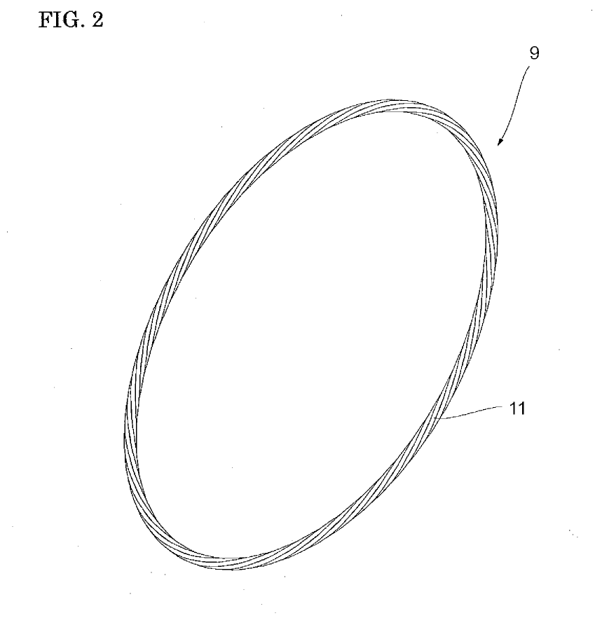

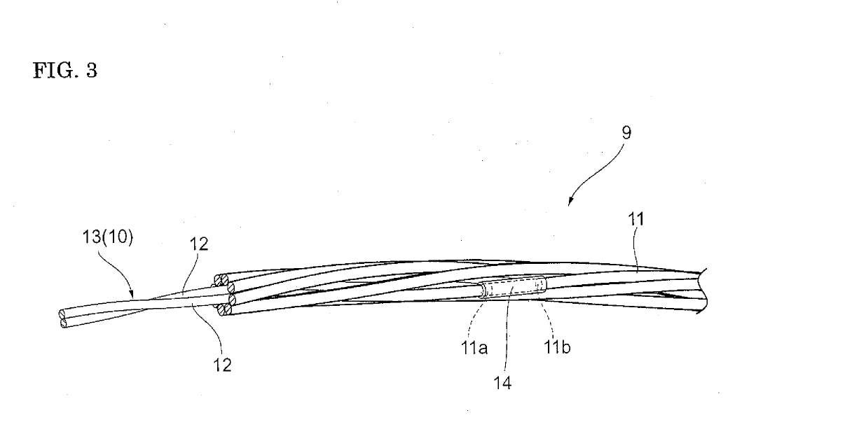

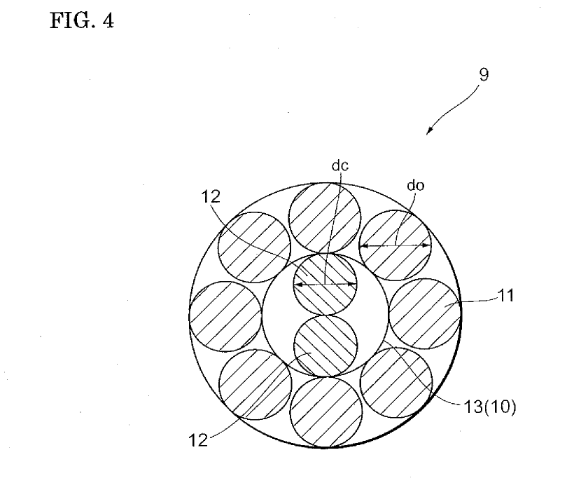

FIG. 2 is a perspective view of the bead cord 9, FIG. 3 is an enlarged partial perspective view of the bead cord 9, and FIG. 4 is an enlarged sectional view of the bead cord 9. In each of the drawings, the bead cord 9 includes an annular core 10 and a side wire 11 helically wound in a layer around the annular core 10.

The annular core 10 is made of a strand wire 13 including two twisted core wires 12. When the annular core 10 has a strand structure, an elongation of the annular core 10 can be easily attained. The core wires 12 have the same diameter.

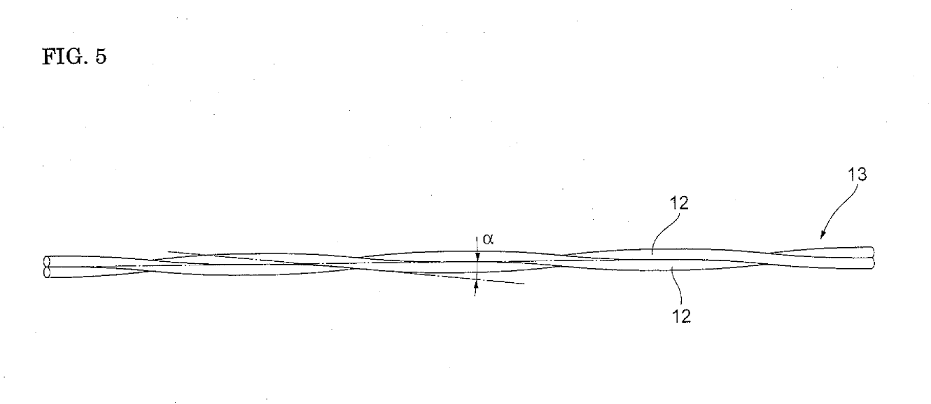

The both end surfaces of each of the core wires 12 which form the annular core 10 are joined to each other by welding. In this case, both end surfaces of each core wire 12 can be easily bonded without causing an increase in diameter of a joint portion of the core wire 12. The twisting angle α (refer to FIG. 5) of the strand wire 13 composed of the core wires 12 is preferably 5.0 to 18.5°.

The core wires 12 are composed of an alloy steel wire. The material of the core wires 12 contains, for example, 0.08 to 0.27% by mass of C, 0.30 to 2.00% by mass of Si, 0.50 to 2.00% by mass of Mn, and 0.20 to 2.00% by mass of Cr; and further containing at least one of Al, Nb, Ti, and V in a range of 0.001 to 0.100% by mass, the balance being composed of Fe and inevitable impurities. With this composition, weldability of both end surfaces of each core wire 12 is increased, thereby increasing the breaking strength of the annular core 10. If required, the surface of each core wire 12 is plated with brass (Cu—Zn alloy) or the like.

Further, the core wires 12 may be composed of carbon steel containing 0.28 to 0.56% by mass of C. When such carbon steel is used as the material for the core wires 12, it is possible to sufficiently secure strength necessary for the core wires 12 and secure ductility of the core wires 12 after both end surface of each core wire 12 are welded. In this case, if required, the surface of each core wire 12 is plated with brass or the like.

The side wire 11 is helically wound in a plurality of turns around the annular core 10. The material of the side wire 11 is a high-carbon steel wire containing 0.7% by mass or more of C. The surface of the side wire 11 is plated with brass or the like.

The winding direction of the side wire 11 on the annular core 10 is preferably opposite to the twisting direction of the core wires 12. In this case, the side wire 11 is suppressed from dropping into the ply (space between the core wires 12) of the annular core 10 when the side wire 11 is wound around the annular core 10, thereby decreasing the influence on windability of the side wire 11 around the annular core 10.

A factor which determines the windability of the side wire 11 around the annular core 10 is a difference in flexural rigidity between the annular core 10 and the side wire 11. In order to appropriately determine a difference in flexural rigidity, the relation between the wire diameters of the core wire 12 and the side wire 11 is represented by the following expression:

$${\sum }_{i = 1}^{n} {d}_{ci}^{4} \geq {d}_{o}^{4} \qquad [ Equation 2 ]$$

wherein n is the number of the core wires 12; d_{ci}, the wire diameter of the core wire 12; and dₒ, the wire diameter of the side wire 11.

When the relational expression is satisfied, the flexural rigidity of the annular core 10 is equivalent to or higher than that of the side wire 11 in spite of the smaller wire diameter d_{ci} of the core wire 12 than the wire diameter dₒ of the side wire 11, thereby facilitating helical winding of the side wire 11 around the annular core 10.

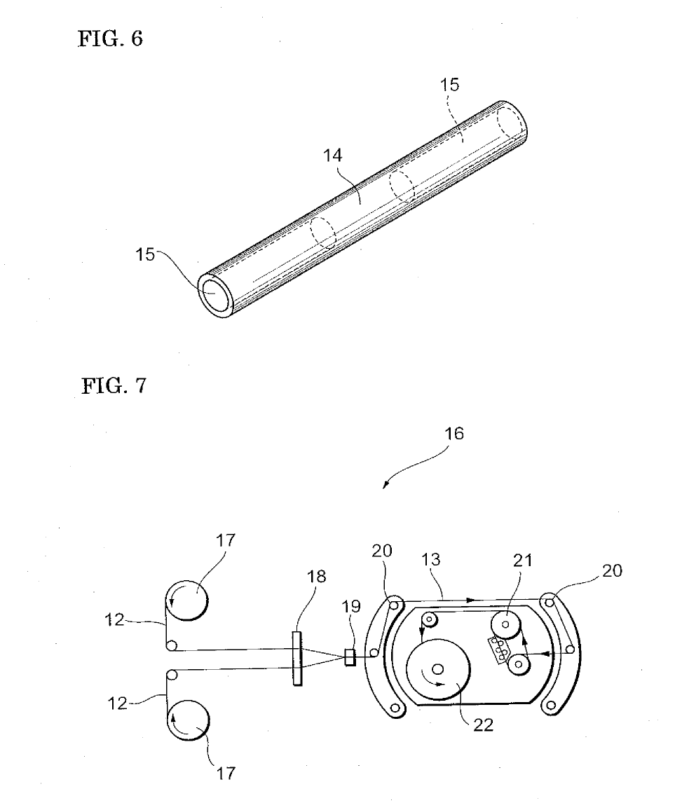

The winding leading end 11a of the side wire 11 is connected to the winding trailing end lib through a substantially cylindrical connecting member 14 (refer to FIG. 3). As shown in FIG. 6, the connecting member 14 has a pair of connecting recessions 15 at both ends in which the winding leading end 11a and the winding trailing end lib of the side wire 11 are respectively inserted. Each of the connecting recessions 15 has a circular sectional shape. As the connecting member 14, a sleeve may be used.

In the bead cord 9 having the above-described constitution, the wire diameter d_{ci} of each of the core wires 12 which constitute the annular core 10 is, for example, 0.95 mm. Further, the twisting direction of each core wire 12 is the Z-twisting direction, the twisting pitch of each core wire 12 is, for example, 12.5 mm, and the twist angle α is, for example, 13.4°. The material of the core wires 12 is alloy steel having a composition containing, for example, 0.17% by mass of C, 0.93% by mass of Si, 1.50% by mass of Mn, 0.41% by mass of Cr, 0.08% by mass of Ti, and 0.03% by mass of Al. The material of the core wires 12 may be carbon steel having a composition containing, for example, 0.51% by mass of C, 0.22% by mass of Si, 0.46% by mass of Mn, 0.014% by mass of P, and 0.006% by mass of S.

The wire diameter dₒ of the side wire 11 is, for example, 1.10 mm. Further, the side wire 11 is wound in eight turns in the S direction around the annular core 10. The material of the side wire 11 has a composition containing, for example, 0.83% by mass of C, 0.19% by mass of Si, and 0.51% by mass of Mn.

Next, the method for producing the bead cord 9 will be described. First, the annular core 10 is produced using a stranding machine 16 as shown in FIG. 7.

Specifically, each of the core wires 12 unwound from two supply bobbins 17 is transferred to a stranding port die 19 through a guide hole of a guide plate 18. The core wires 12 are helically twisted together in the standing port die 19 to obtain the stand wire 13 of a two stranded-structure. The strand wire 13 is wound on a winding bobbin 22 through a plurality of rollers 20 and a take-up capstan 21.

Next, the strand wire 13 is unwound from the winding bobbin 22 and cut into a predetermined length, and then both ends of each of the core wires 12 which constitute the strand wire 13 are abutted and heat-welded together. As a result, the annular core 10 including the strand wire 13 is obtained.

When the strand wire 13 is formed so that the twist angle α (refer to FIG. 5) of each of the core wires 12 which constitute the strand wire 13 is 5.0° or more as described above, substantially no parting occurs at both ends of each core wire 12, thereby facilitating the work of welding the core wires 12.

When the core wires 12 have different diameters in producing the strand wire 13 using the stranding machine 16, a balance between residual torsions inherent in the respective core wires 12 is broken with a change with time, leaving residual stress in the strand wire 13. As a result, the resulting strand wire 13 tends to have poor linearity. In this case, the shape stability of the annular core 10 is degraded, and thus subsequent winding (described below) of the side wire 11 may be affected. In this embodiment, since the core wires 12 have the same diameter, substantially no difference in inherent residual torsion occurs between the core wires 12. Therefore, the residual torsion of the strand wire 13 is stabilized regardless of changes with time, thereby obtaining the strand wire 13 with excellent linearity and thus stabilizing the shape of the annular core 10. Therefore, winding of the side wire 11 is little adversely affected.

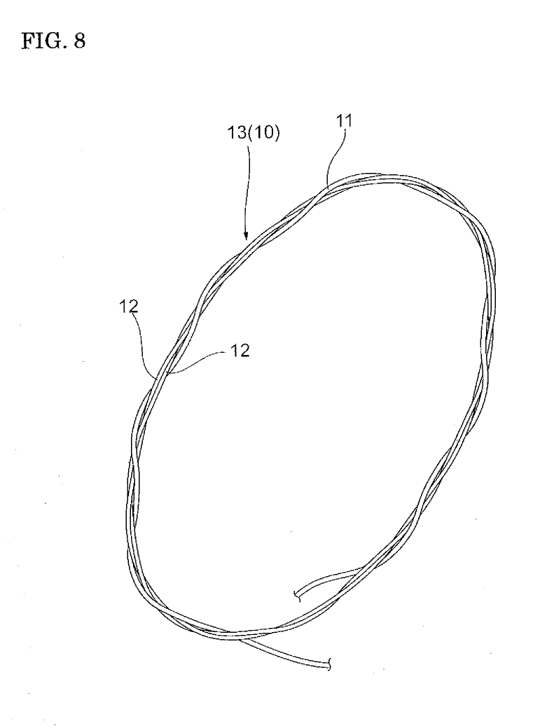

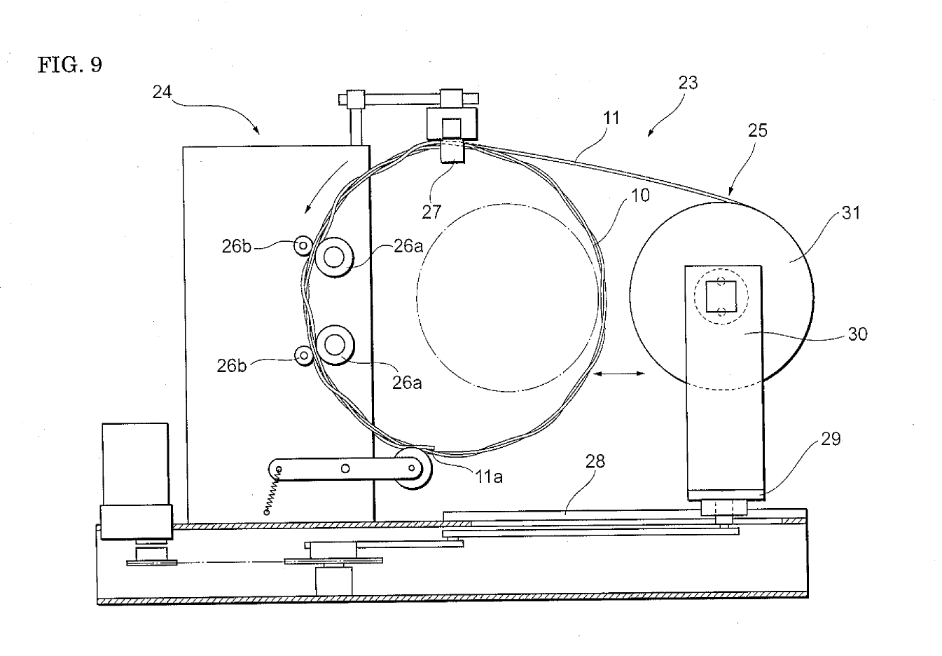

Then, as shown in FIG. 8, the side wire 11 is helically wound in a plurality of turns around the annular core 10 using a wire winding machine 23 as shown in FIG. 9.

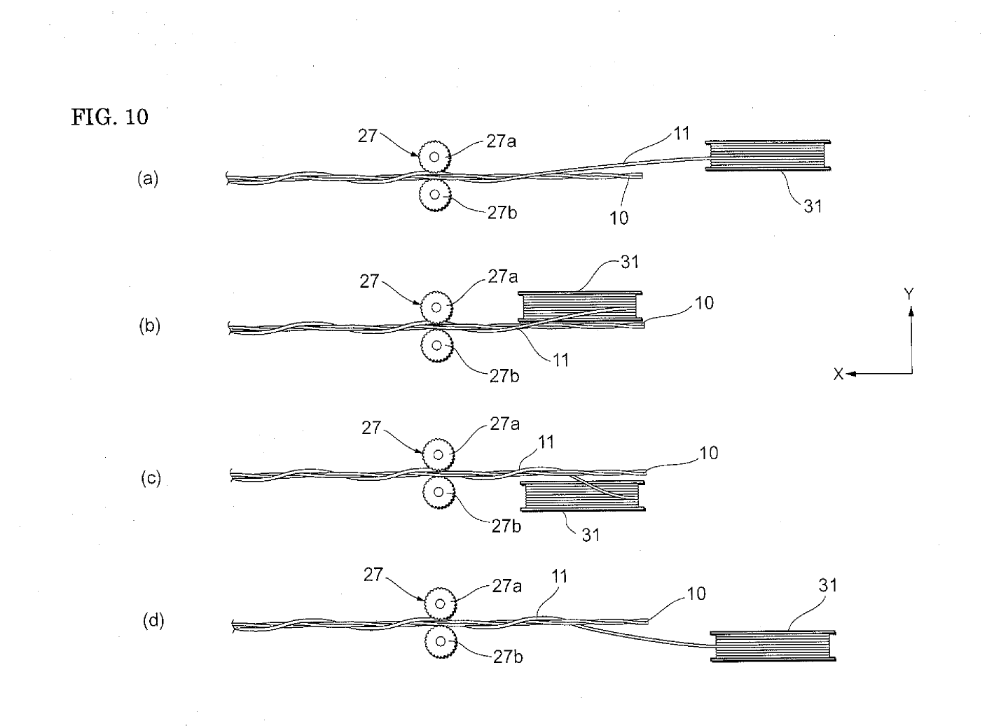

The wire winding machine 23 is provided with a driving unit 24 and a supply unit 25. The driving unit 24 includes a plurality of pinch rollers 26a and 26b which rotate the annular core 10 in the circumferential direction, and a clamp portion 27 disposed above the pinch rollers 26a and 26b, for guiding the annular core 10 while clamping it. As shown in FIG. 10, the clamp portion 27 includes rollers 27a and 27b which rotate the annular core 10 in the circumferential direction while suppressing lateral run-out of the annular core 10 by clamping it upright.

The supply unit 25 includes a rail 28, a moving base 29 sliding along the rail 28, and a supply reel 31 provided above the moving base 29 through a stand 30, for winding the side wire 11. The supply reel 31 can be moved in the direction (the Y direction shown in the drawing) perpendicular to the extension direction of the rail 28, as shown in FIG. 10.

When the side wire 11 is wound around the annular core 10 using the wire winding machine 23, first, the side wire 11 is unwound from the supply reel 31 disposed outside the annular core 10 and the winding leading end 11a of the side wire 11 is temporarily bonded to the annular core 10 using an adhesive tape or the like. Then, the annular core 10 is rotated in the circumferential direction to start winding of the side wire 11 around the annular core 10.

Specifically, first, as shown in FIGS. 10(a) and 10(b), the supply reel 31 is moved in the X direction from an initial position outside of the annular core 10 so as to reach a region inside of the annular core 10 (refer to a one-dot chain line in FIG. 9). Then, the supply reel 31 is moved in the Y direction across the plane of the annular core 10 as shown in FIGS. 10(b) and 10(c). Then, the supply reel 31 is moved in the X direction away from the annular core 10 as shown in FIGS. 10(c) and 10(d) and returned to the initial position shown in FIG. 10(a). This step is repeated to helically wind the side wire 11 in a plurality of turns around the annular core 10.

Then, the winding leading end 11a and the winding terminal ends lib of the side wire 11 are inserted into the respective connecting recesses 15 of the connecting member 14 to connect the winding leading end 11a and the winding terminal ends lib of the side wire 11 to each other through the connecting member 14. As a result, the annular bead cord 9 as shown in FIG. 2 is completed.

The bead cord 9 produced as described above is incorporated into the bead portion 6 after the vehicle tire 1 is molded.

In this embodiment, the strand wire 13 including the two twisted core wires 12 is used for the annular core 10, and the wire diameter d_{ci} of the core wires 12 and the wire diameter dₒ of the side wire 11 are determined so as to satisfy the above-described expression (A). Therefore, the elongation of the annular core 10 is secured while flexural rigidity of the annular core 10 is secured. Thus, the elongation of the annular core 10 can be brought close to the elongation of the side wire 11. The twist pitch (twist angle α) of the strand wire 13 which forms the annular core 10 is appropriately controlled so that the elongation of the annular core 10 can be made the same as that of the side wire 11. In this case, the elongation of the bead cord 9 in the radial direction can be minimally attained, and thus the diameter of the bead cord 9 is minimally increased.

In addition, the annular core 10 is easily elongated, thereby preventing breakage or fatigue of the annular core 10 in an early stage. Therefore, the durability of the annular core 10 and the bead cord 9 can be improved.

In this case, the strand wire 13 is formed so that the twist angle α of each core wire 12 is 18.5° or less as described above, and thus the elongation of the annular core 10 is not made excessive. Therefore, when the bead cord 9 is incorporated into the bead portion 6, the unity between the annular core 10 and the side wire 11 is maintained, thereby facilitating the work of incorporating the bead cord 9.

Further, since the side wire 11 is wound around the annular core 10 having flexural rigidity equivalent to that of the side wire 11, automatic winding of the side wire 11 can be sufficiently realized, and the bead cord 9 having a stable shape and structure can be obtained.

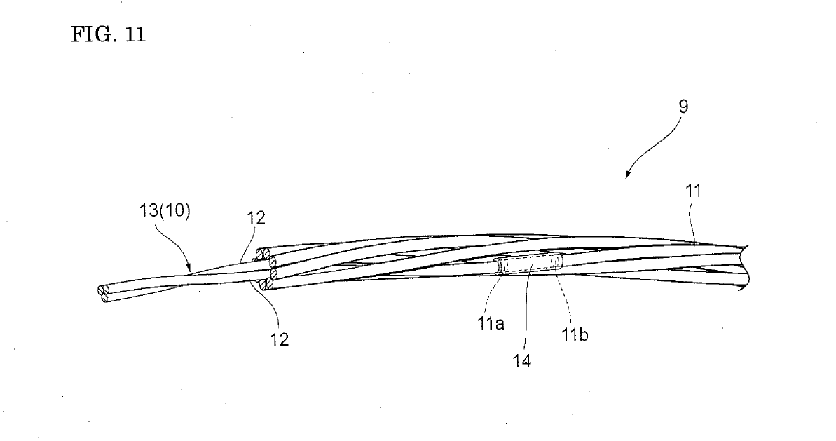

FIG. 11 shows a modified example of the bead cord 9 of this embodiment. In the drawing, the annular core 10 is composed of a strand wire 13 including three twisted core wires 12.

In this example, the wire diameter d_{ci} of each of the core wires 12 is, for example, 1.0 mm. Further, the twisting direction of each core wire 12 is the Z-twisting direction, the twisting pitch of each core wire 12 is, for example, 20.0 mm, and the twist angle α is, for example, 10.3°. The wire diameter dₒ of the side wire 11, for example, 13 mm. Further, the side wire 11 is wound in eight turns in the S direction around the annular core 10.

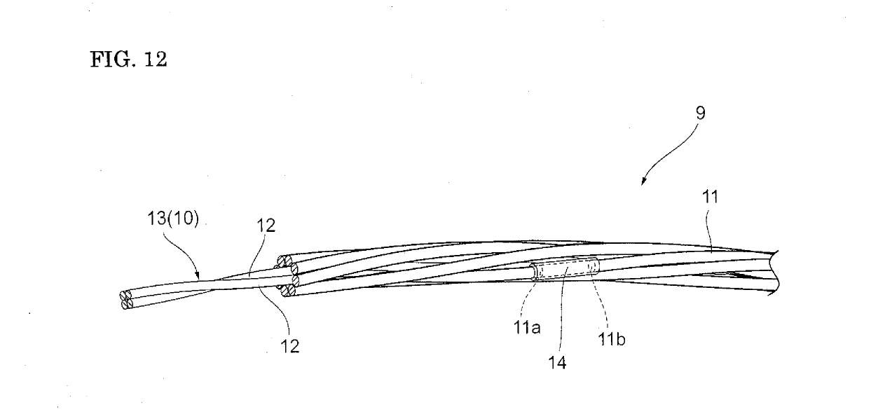

FIG. 12 shows another modified example of the bead cord 9 of this embodiment. In the drawing, the annular core 10 is composed of a strand wire 13 including four twisted core wires 12.

In this example, the wire diameter d_{ci} of each of the core wires 12 is, for example, 0.95 mm. Further, the twisting direction of each core wire 12 is Z-twisting, the twisting pitch of each core wire 12 is, for example, 20.0 mm, and the twist angle α is, for example, 11.9°. The wire diameter dₒ of the side wire 11, for example, 1.3 mm. Further, the side wire 11 is wound in eight turns in the S direction around the annular core 10.

The present invention is not limited to the above-described embodiment. For example, in the embodiment, the strand wire 13 including 2 to 4 twisted core wires 12 is used for the annular core 10. However, a strand wire 13 including 5 or more twisted core wires 12 may be used within a range in which the rigidity relation is satisfied.

Although, in the embodiment, the side wire 11 is helically wound in a layer around the annular core 10, the side wire 11 may be wound in a plurality of layers around the annular core 10.

1. A bead cord comprising;
an annular core; and
a side wire helically wound around the annular core,
wherein the annular core is made of a strand wire including a plurality of twisted core wires.

2. The bead cord according to claim 1, wherein the following equation is satisfied:
$${\sum }_{i = 1}^{n} {d}_{ci}^{4} \geq {d}_{o}^{4}$$
wherein n is the number of the core wires, d_{ci} is the diameter of the core wires, and dₒ is the diameter of the side wire.

3. The bead cord according to claim 1, wherein the plurality of core wires have substantially the same diameter.

4. The bead cord according to claim 1, wherein the winding direction of the side wire on the annular core is opposite to the twisting direction of the plurality of core wires.

5. The bead cord according to claim 1, wherein the end surfaces of each of the core wires which form the annular core are welded together.

6. The bead cord according to claim 5, wherein the twist angle of each core wire is 5.0 to 18.5°.

7. The bead cord according to claim 5, wherein the material of the core wires is alloy steel containing 0.08 to 0.27% by mass of C, 0.30 to 2.00% by mass of Si, 0.50 to 2.00% by mass of Mn, and 0.20 to 2.00% by mass of Cr, and further containing at least one of Al, Nb, Ti, and V in a range of 0.001 to 0.100% by mass, the balance being composed of Fe and inevitable impurities.

8. The bead cord according to claim 5, wherein the material of the core wires is carbon steel containing 0.28 to 0.56% by mass of C.

9. A vehicle tire comprising a bead portion in which the bead cord according to claim 1 is embedded.

10. The bead cord according to claim 2, wherein the plurality of core wires have substantially the same diameter.

11. The bead cord according to claim 2, wherein the winding direction of the side wire on the annular core is opposite to the twisting direction of the plurality of core wires.

12. The bead cord according to claim 3, wherein the winding direction of the side wire on the annular core is opposite to the twisting direction of the plurality of core wires.

13. The bead cord according to claim 2, wherein the end surfaces of each of the core wires which form the annular core are welded together.

14. The bead cord according to claim 3, wherein the end surfaces of each of the core wires which form the annular core are welded together.

15. The bead cord according to claim 4, wherein the end surfaces of each of the core wires which form the annular core are welded together.

16. The bead cord according to claim 6, wherein the material of the core wires is alloy steel containing 0.08 to 0.27% by mass of C, 0.30 to 2.00% by mass of Si, 0.50 to 2.00% by mass of Mn, and 0.20 to 2.00% by mass of Cr, and further containing at least one of Al, Nb, Ti, and V in a range of 0.001 to 0.100% by mass, the balance being composed of Fe and inevitable impurities.

17. The bead cord according to claim 6, wherein the material of the core wires is carbon steel containing 0.28 to 0.56% by mass of C.

18. A vehicle tire comprising a bead portion in which the bead cord according to claim 2 is embedded.
